(19) United States
(12) Patent Application Publication
(10) Pub. No.: US 2005/0085582 A1
(43) Pub. Date: Apr. 21, 2005

(54) Tyre with low rolling resistance, tread band and elastomeric composition used therein

(76) Inventors: Maurizio Galimberti, Milano (IT); Daniela Senatore, Breda (IT); Luigi Fino, Bovisio Masciago (IT); Giuseppina Ratti, Seregno (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/494,460

(22) PCT Filed: Oct. 30, 2001
(86) PCT No.: PCT/IB01/02046

(51) Int. Cl. B60C 5/00; C08K 3/34

(52) U.S. Cl. 524/492; 152/450

(57) ABSTRACT

An elastomeric composition includes at least one diene elastomeric polymer, at least one reinforcing filler including silica, at least one silica coupling agent including at least one hydrolyzable silane group, and titanium dioxide. A weight ratio of the at least one silica coupling agent to the titanium dioxide is greater than or equal to 0.5:1. Also disclosed is a tyre, tread band, and cross-linked elastomeric manufactured article including the elastomeric composition. The tyre includes at least one element of cross-linked elastomeric material including the elastomeric composition. The tread band may be that at least one element.

The present invention relates to a tyre for vehicle wheels, to a tread band and to a cross-linkable elastomeric composition.

More particularly, the present invention relates to a tyre for vehicle wheels comprising at least one element of cross-linked elastomeric material including at least one reinforcing filler comprising silica, at least one silica coupling agent and titanium dioxide.

The present invention also relates to a tread band including a cross-linkable elastomeric composition comprising at least one reinforcing filler including silica, at least one silica coupling agent and titanium dioxide, as well as an elastomeric composition comprising at least one reinforcing filler including silica, at least one silica coupling agent and titanium dioxide.

In the rubber industry, in particular in the industry for production of vehicle wheel tyres, use of elastomeric compositions is known in which reinforcing fillers are incorporated into the polymeric base for the purpose of improving the features of the cross-linked manufactured article, in particular mechanical properties and resistance to abrasion. Due to its high reinforcing power, carbon black is the most widely used reinforcing filler. However, carbon black gives the cross-linked manufactured article marked hysteresis features, i.e. an increase in the heat dissipated under dynamic conditions which, as known, in the case of a tyre, gives rise to an increase of the rolling resistance of the tyre itself. This brings about an increase in the vehicle fuel consumption and, consequently, an increase both in the locomotion costs and in air pollution. An attempt to reduce these negative effects can be made by using smaller amounts of carbon black and/or a carbon black having a reduced surface area. This however, inevitably brings to a reduction in the reinforcing action, which will worsen the mechanical properties and the abrasion resistance of the finished product.

For the purpose of reducing the hysteresis features of cross-linked manufactured articles, use of the so-called “white” reinforcing fillers is known, such as gypsum, talc, kaolin, bentonite, titanium dioxide, silicates of various types and, above all, silica which can fully or partly replace carbon black. In this connection, reference can be made to European Patent EP 501,227, for example.

As above stated, among the so-called “white” fillers use of titanium dioxide is also known, in addition to silica.

With reference to this, the Japanese Patent Application JP 2000/38477 discloses an elastomeric composition to be used for manufacture of tyre tread bands, comprising a blend including 10 to 50 parts by weight of titanium dioxide and 30 to 90 parts by weight of silica based on 100 parts by weight of a diene elastomeric polymer, and a coupling agent in an amount of between 5% and 15% with respect to silica. The coupling agent can be selected from sulphur-containing organosilane compounds such as bis(3-triethoxysilylpropyl)tetrasulphide, 3-mercapto-propyltrimethoxysilane, 2-mercaptoethyl-trimethoxysilane, for example. Said composition would be provided with good Mooney viscosity and would enable tread bands provided with a better resistance to wear to be obtained.

Use of said reinforcing fillers, in particular silica, involves a series of drawbacks, substantially correlated with the weak affinity of said fillers for the elastomeric polymers commonly used in tyre production. In particular, in order to enable silica to have a good dispersion degree in the polymeric base the elastomeric compositions are required to be submitted to a prolonged thermomechanical mixing action. In addition, silica particles that have a strong tendency to coalesce even when finely dispersed in a polymeric base, adversely affect storage stability of the unvulcanized elastomeric compositions forming agglomerates, and thus causing a great increase in viscosity. Finally, the acid groups present in silica can cause strong interactions with the basic substances usually present in the elastomeric compositions such as vulcanization accelerators for example, thereby reducing cross-linking degree and velocity.

To increase affinity of silica for the elastomeric matrix, appropriate coupling agents are currently used such as sulphur-containing organosilane products for example, which have two different groups: a first group which is able to interact with the silanol groups present on the silica surface, a second group able to promote interaction with the sulphur-vulcanizable elastomeric polymers. Use of said coupling agents however, limits the maximum temperature that can be achieved during the mixing and thermomechanical-working operations of the elastomeric composition, under penalty of an irreversible thermal degradation of the coupling agent. In addition, the high cost of said coupling agents adversely affects the cost of the finished product.

For the purpose of overcoming the above drawbacks, in the known art introduction of other compounds able to promote silica reaction with the coupling agent thereby improving interaction thereof with the elastomeric polymers has been suggested.

For instance, the European Patent Application EP 801,112 discloses elastomeric compositions comprising silica, a silane as the coupling agent and/or a polysiloxane having alkoxysilyl groups in the molecule, a condensation catalyst in an amount of between 0.5% and 200% by weight with respect to said coupling agent and/or to said polysiloxane. Said condensation catalyst can be selected from metal carboxylates such as tetraisopropyl titanate, dibutyl tin dilaurate, zinc octylate, for example; or from amines such as dimethyl stearylamine, etc., for example. Addition of the coupling agent and/or polysiloxane and the condensation catalyst to said elastomeric compositions would enable reaction between silica and the coupling agent and/or polysiloxane to be accelerated and, consequently, the physical properties of said elastomeric compositions to be improved, in particular stress at tensile deformation, wear resistance, tandelta and other physical properties.

Patent application EP 1,031,604 describes an elastomer composition comprising (a) 100 parts by weight of an elastomer containing an olefinic unsaturation, which is selected from conjugated diene homopolymers and copolymers and from copolymers of at least one conjugated diene with an aromatic vinyl compound; (a) 10 to 150 phr of silica; (c) 0.1 to 15 phr of a sulphur-containing organosilane compound; (d) 0.1 to 10 phr of a tin carboxylate. Said tin carboxylate (for example tin octanoate) would be able to give the elastomer compositions improved both mechanical and dynamic properties, better abrasion resistance as well as less rolling resistance.

The Applicant has now found that titanium dioxide added to elastomer compositions including silica and a silica coupling agent, is able to promote the silanization reaction (increase in yield) and therefore, to enable, if required, a reduction in the amount of said coupling agent. In addition, titanium dioxide is able to improve the static mechanical properties (in particular is able to give a better reinforcing effect), the dynamic mechanical properties (in particular tandelta to high temperatures) and the abrasion resistance of said elastomeric compositions. Also the viscosity values and the rheometric properties of said elastomeric compositions keep within acceptable values, in this way ensuring a good processing and extrusion capability.

Accordingly, in a first aspect the present invention relates to a tyre for vehicle wheels comprising at least one element of cross-linked elastomeric material, in which said element includes an elastomeric composition comprising:
(a) at least one diene elastomeric polymer;
(b) at least one silica-including reinforcing filler;
(c) at least one silica coupling agent containing at least one hydrolyzable silane group;
(d) titanium dioxide; wherein the weight ratio between said coupling agent (c) and titanium dioxide (d) is not less than 0.5, preferably comprised between 2 and 6.

According to a preferred embodiment, the present invention relates to a tyre for vehicle wheels comprising:
a carcass structure with at least one carcass ply shaped in a substantially toroidal configuration, the opposite lateral edges of which are associated with respective right-hand and left-hand bead wires, each bead wire being enclosed in a respective bead;
a belt structure comprising at least one belt strip applied in a circumferentially external position relative to said carcass structure;
a tread band superimposed circumferentially on said belt structure;
a pair of side walls applied laterally on opposite sides relative to said carcass structure;
   wherein said element which includes said elastomeric composition is the tread band.

In another aspect, the present invention relates to a tread band for vehicle wheel tyres including a cross-linkable elastomeric composition comprising:
(a) at least one diene elastomeric polymer;
(b) at least one silica-including reinforcing filler;
(c) at least one silica coupling agent containing at least one hydrolyzable silane group;
(d) titanium dioxide; wherein the weight ratio between said coupling agent (c) and titanium dioxide (d) is not less than 0.5, preferably comprised between 2 and 6.

In a further aspect, the present invention relates to an elastomeric composition comprising:
(a) at least one diene elastomeric polymer;
(b) at least one silica-including reinforcing filler;
(c) at least one silica coupling agent containing at least one hydrolyzable silane group;
(d) titanium dioxide; wherein the weight ratio between said coupling agent (c) and titanium dioxide (d) is not less than 0.5, preferably comprised between 2 and 6.

In a still further aspect, the present invention relates to a cross-linked elastomeric manufactured article obtained by cross-linking an elastomeric composition comprising:
(a) at least one diene elastomeric polymer;
(b) at least one silica-including reinforcing filler;
(c) at least one silica coupling agent containing at least one hydrolyzable silane group;
(d) titanium dioxide; wherein the weight ratio between said coupling agent (c) and titanium dioxide (d) is not less than 0.5, preferably comprised between 2 and 6.

In a preferred embodiment, the diene elastomeric polymer (a) to be used in accordance with the present invention can be selected from those currently employed in sulphur cross-linkable elastomeric compositions, particularly suitable for tyre manufacture, i.e. among unsaturated-chain elastomeric polymers or copolymers having a glass transition temperature (T_{g}) generally lower than 20° C., preferably comprised between 0° C. and −90° C. These polymers and copolymers can be of natural origin or they can be obtained by solution polymerization, emulsion polymerization, or gas-phase polymerization of one or more conjugated diolefins, possibly mixed with at least one co-monomer selected from monovinylarenes and/or polar co-monomers in amounts not higher than 60% by weight.

Conjugated diolefins generally have from 4 to 12, preferably from 4 to 8, carbon atoms and can be selected for example from the group comprising: 1,3-butadiene, isoprene, 2,3-dimethyl-1,3-butadiene, 1,3-pentadiene, 1,3-hexadiene, 3-buthyl-1,3-octadiene, 2-phenyl-1,3-butadiene and mixtures thereof. Particularly preferred are 1,3-butadiene and isoprene.

Monovinylarenes possibly usable as co-monomers generally have from 8 to 20, preferably from 8 to 12 carbon atoms, and can be selected from, for example: styrene; 1-vinylnaphthalene; 2-vinylnaphthalene; some alkyl, cycloalkyl, aryl, akylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Particularly preferred is styrene.

Polar co-monomers possibly usable can be, for example, selected from: vinylpyridines, vinylquinolines, acryl and alkylacryl acid esters, nitriles, or mixtures thereof such as, for example, methylacrylate, ethylacrylate, methyl methacrylate, ethyl methacrylate, acrylonitrile, or mixtures thereof.

Preferably, the diene elastomeric polymer (a) usable in the present invention can be for example selected from: cis-1,4-polyisoprene (natural or synthetic, preferably natural rubber), 3,4-polyisoprene, polybutadiene (in particular high “1,4-cis” polybutadiene), possibly halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

The elastomeric composition in accordance with the present invention can possibly comprise at least one elastomeric polymer of at least one monoolefin with at least one olefinic co-monomer or derivatives thereof (e). Monoolefins can be selected from: ethylene and α-olefins generally having from 3 to 12 carbon atoms, such as, for example, propylene, 1-butene, 1-pentene, 1-hexene, 1-octene, or mixtures thereof. Preferred are: copolymers of ethylene and an α-olefin, and possibly a diene; homopolymers of isobutene or copolymers thereof with smaller amounts of a diene, possibly at least partly halogenated. The possibly present diene generally has from 4 to 20 carbon atoms and is preferably selected from: 1,3-butadiene, isoprene, 1,4-hexadiene, 1,4-cyclohexadiene, 5-ethylidyne-2-norbornene, 5-methylidyne-2-norbornene, 5-vinyl-2-norbornene, or mixtures thereof. Of them particularly preferred are: ethylene/propylene (EPR) copolymers or ethylene/propylene/diene (EPDM) copolymers; polyisobutene; butyl rubbers; halobutyl rubbers, in particular chlorobutyl or bromobutyl rubbers; or mixtures thereof.

Also used can be a diene elastomeric polymer (a) or an elastomeric polymer (e) functionalized by reaction with suitable terminating or coupling agents. In particular, diene elastomeric polymers obtained by anionic polymerization in the presence of an organometallic initiator (in particular an organolithium initiator) can be functionalized by reaction of the residual organometallic groups derived from the initiator with suitable terminating or coupling agents such as, for example, imines, carbodiimides, alkyltin halides, substituted benzophenones, alkoxy- or aryloxy-silanes (see, for example, European Patent EP 451,604 or U.S. Pat. Nos. 4,742,124 and 4,550,142).

The elastomeric composition in accordance with the present invention may possibly comprise at least one thermoplastic polymer having a main hydrocarbon chain to which hydrophilic groups are bonded (f). The preferred ones are polyacrylic acid, polymethacrylic acid, polyhydroxyalkylalkylate, polyalkylacrylate, polyacrylamide, acrylamide/acrylic acid copolymers, polyvinyl alcohol, polyvinyl acetate, vinylalcohol/vinylacetate copolymers, ethylene/vinylacetate copolymers, ethylene/vinylalcohol copolymers, ethylene/vinylalcohol/vinylacetate terpolymers, polyvinylsulfonic acid, polystyrene sulfonate, or mixtures thereof. For a more detailed description of said thermoplastic polymer (f) reference can be made for example, to the Patent Application Wo 01/49785 in the name of the same Applicant.

According to a preferred embodiment, the silica-including reinforcing filler (b) can generally be a pyrogenic silica or preferably a precipitated silica, having a BET surface area (measured according to ISO standard 5794/1) comprised between 50 m²/g and 500 m²/g, preferably between 70 m²/g and 200 m²/g.

The silica-including reinforcing filler (b) is present in the elastomeric composition in an amount preferably comprised between 0.1 phr and 120 phr, more preferably between 10 phr and 90 phr.

For the purposes of the present description and of the claims, the term “phr” means the parts by weight of a given component of the elastomeric composition per 100 parts by weight of elastomeric base.

The elastomeric composition in accordance with the present invention may possibly include a further reinforcing filler that can be for example selected from: carbon black, alumina, aluminosilicates, calcium carbonate, kaolin, or mixtures thereof.

The carbon black types to be used in accordance with the present invention can be selected from those conventionally used in tyre manufacture, generally having a surface area of not less than 20 m²/g (determined by CTAB absorption as described in ISO standard 6810).

According to a preferred embodiment, the silica coupling agent containing at least one hydrolysable silane group (c) also contains at least one sulphur atom. Preferably said coupling agent can be selected from the compounds of formula (I):
Z-Alk-Sₙ-Alk-Z (I)
wherein Z is selected from the following groups: —Si(R₁)₂(R₂), —Si(R₁)(R₂)₂, and —Si(R₂)₃, wherein R₁ is a C₁-C₄ alkyl group, a cyclohexyl or a phenyl group and R₂ is a C₁-C₈ alkoxy group, or a C₅-C₈ cycloalkoxy group; Alk is a divalent hydrocarbon group having from 1 to 18 carbon atoms, and n is a number included between 2 and 8.

Specific examples of compounds of formula (I) to be used in accordance with the present invention are:
3,3′-bis(trimethoxysilylpropyl)disulfide,
3,3′-bis(triethoxysilylpropyl)disulfide,
3,3′-bis(triethoxysilylpropyl)tetrasulfide,
3,3′-bis(tri-etoxysilylpropyl)octasulfide,
3,3′-bis(trimethoxysilylpropyl)tetrasulfide,
2,2′bis(triethoxysilylethyl)tetrasulfide,
3,3′-bis(trimethoxysilylpropyl)trisulfide,
3,3′-bis(triethoxysilylpropyl)trisulfide
3,3′-bis(tributoxysilylpropyl)disulfide,
3,3′-bis(trimethoxysilylpropyl)hexasulfide,
3,3′-bis(trimethoxysilylpropyl)octasulfide,
3,3′-bis(trioctoxysilylpropyl)tetrasulfide,
3,3′-bis-(trihexoxysilylpropyl)disulfide,
3,3′-bis(tri-2-ethylhexoxysilylpropyl)trisulfide,
3,3′-bis(triisooctoxylsilylpropyl)tetrasulfide,
3,3′-bis(tri-t-butoxysilylpropyl)disulfide,
2,2′-bis(methoxydiethoxysilylethyl)tetrasulfide,
2,2′-bis(tripropoxysilylethyl)pentasulfide,
3,3′-bis(tricyclohexoxysilylpropyl)tetrasulfide,
3,3′-bis(tricyclopentoxysilylpropyl)trisulfide,
2,2′-bis(tri-2-methylcyclohexoxysilylethyl)tetrasulfide,
bis(trimethoxysilylmethyl)tetrasulfide,
3-methoxyethoxypropoxysilyl-3′-diethoxybutoxysilylpropyltetrasulfide,
2,2′-bis(dimethylmethoxysilylethyl)disulfide,
2,2′-bis-(dimethyl-s-butoxysilylethyl)trisulfide,
3,3′-bis(methylbutylethoxysilylpropyl)tetrasulfide,
3,3′-bis(di-t-butylmethoxysilylpropyl)tetrasulfide,
2,2′-bis(phenylmethylmethoxysilylethyl)trisulfide,
3,3′-bis(diphenylisopropoxysilylpropyl)tetrasulfide,
3,3′-bis(diphenylciclohexoxysilylpropyl)disulfide,
3,3′-bis(dimethylethylmercaptosilylpropyl)tetrasulfide,
2,2′-bis(methyldimethoxysilylethyl)trisulfide,
2,2′-bis(methylethoxypropoxysilylethyl)tetrasulfide,
3,3′-bis(diethylmethoxysilylpropyl)tetrasulfide,
3,3′-bis(ethyl-di-s-butoxysilylpropyl)disulfide,
3,3′-bis(propyldiethoxysilylpropyl)disulfide,
3,3′-bis(buthyldimethoxysilylpropyl)trisulfide,
3,3′-bis(phenyldimethoxysilylpropyl)tetrasulfide,
3-phenylethoxybutoxysilyl-3′-trimethoxysilylpropyltetrasulfide,
4,4′bis(trimethoxysilylbutyl)tetrasulfide,
6,6′-bis(triethoxysilylhexyl)tetrasulfide,
12,12′-bis(triisopropoxysilyldodecyl)disulfide,
18,18′-bis(trimethoxysilyloctadecyl)tetrasulfide,
18,18′-bis(tripropoxysisilyloctadecenyl)tetrasulfide,
4,4′-bis(trimethoxysilylbuten-2-yl)tetrasulfide,
4,4′bis(trimethoxysilylcyclohexylene)tetrasulfide,
5,5′-bis(dimethoxymethylsilylpentyl)trisulfide,
3,3′-bis(trimethoxysilyl-2-methylpropyl)tetrasulfide,
3,3′-bis(dimethoxyphenylsilyl-2-methylpropyl)disulfide.

Preferred coupling agents are 3,3-bis(3-triethoxysilylpropyl)tetrasulfide and bis(3-triethoxysilylpropyl)disulfide. Said coupling agents can be used as such or in a suitable mixture with an inert filler (carbon black, for example) so as to facilitate incorporation of same into the elastomeric composition.

The coupling agent (c) is present in the elastomeric composition in an amount preferably comprised between 1 phr and 15 phr, more preferably between 1.5 phr and 10 phr.

According to a preferred embodiment, the titanium dioxide (d) can be selected from those having the following characteristics:
purity: not less than 85%, preferably greater than 98%;
NSA surface area (measured by surface absorption of nitrogen according to ISO standard 5794/1): comprised between 5 m²/g and 200 m²/g, preferably between 8 m²/g and 100 m²/g;
average particle diameter comprised between 10 nm and 400 nm, preferably between 20 nm and 200 nm.

It should be pointed out that, for the purposes of the present description and of the following claims, by the term “titanium dioxide” it is intended compounds of formula TiO₂ as well as their hydrated forms, both crystalline and amorphous forms, in particular the crystalline form of said titanium dioxide (rutile, anatase, or a mixture of said crystalline varieties, for example).

Possibly used may also be a titanium dioxide coated with organic coatings (polyols, for example) or inorganic coatings (alumina, silica, for example).

Said titanium dioxide can be either used as such or it can be mixed with the silica coupling agent before addition to the elastomeric composition.

The titanium dioxide (d) is present in the elastomeric composition in an amount preferably comprised between 0.2 phr and 5 phr, more preferably between 0.5 phr and 3 phr.

The elastomeric composition in accordance with the present invention can be vulcanized following known techniques, in particular using sulphur-based vulcanization systems usually employed for diene elastomeric polymers. For the purpose, in the composition after a thermomechanical working step, a sulphur-based vulcanizing agent is incorporated together with vulcanization accelerators. During the last-mentioned working step, temperature is generally maintained below 120° C., preferably below 100° C., so as to avoid undesirable pre-cross-linking phenomena.

The vulcanizing agent most advantageously used is sulphur, or molecules containing sulphur (sulphur donors), with accelerators and activators known to those skilled in the art.

Activators of particular efficiency are zinc compounds and, in particular, ZnO, ZnCO₃, zinc salts of saturated or unsaturated fatty acids, having from 8 to 18 carbon atoms such as zinc stearate for example, preferably formed in situ in the elastomeric composition starting from ZnO and a fatty acid, as well as BiO, PbO, Pb₃O₄, PbO₂, or mixtures thereof.

Accelerators of common use can be selected from ditiocarbamates, guanidines, thioureas, thiazoles, sulfenamides, thiourames, amines, xanthates, or mixtures thereof.

The elastomeric composition in accordance with the present invention may further comprise other additives of common use selected on the basis of the specific intended application. For instance, added to said composition may be: antioxidants, anti-ageing agents, plasticizers, adhesives, anti-ozone agents, modifying resins, fibres (Kevlar® pulp, for example), or mixtures thereof.

In particular, for the purpose of further improving processability, a plasticizer can be added to the elastomer composition in accordance with the present invention, which is generally selected from mineral oils, vegetable oils, synthetic oils, or mixtures thereof such as, aromatic oil, naphthenic oil, phthalates, soybean oil, or mixtures thereof. The plasticizer amount can generally range between 2 phr and 100 phr, preferably between 5 phr and 50 phr.

Preparation of the elastomeric composition in accordance with the present invention can be accomplished by mixing the polymeric components with the reinforcing filler, the coupling agent and titanium dioxide with the other additives following known techniques. The mixing may be carried out, for example, using an open mixer of open-mill type, or an internal mixer of the type with tangential rotors (Banbury) or with interlocking rotors (Intermix), or in continuous mixers of Ko-Kneader type (Buss) or of co-rotating or counter-rotating twin-screw type.

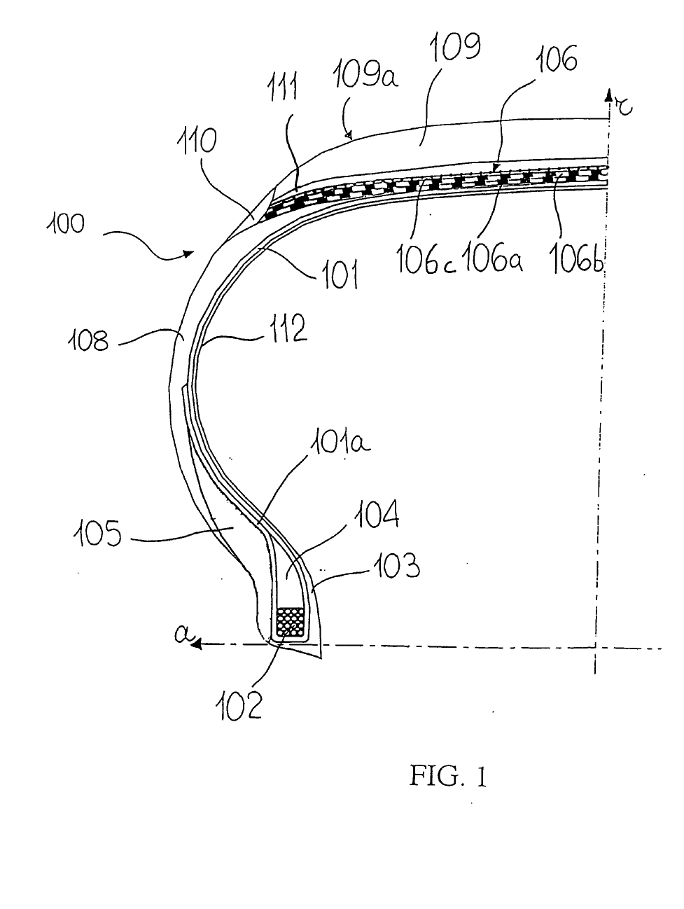

The present invention will be now further illustrated with the aid of some examples, reference being made to the enclosed FIG. 1 representing a sectional view of a portion of a tyre made in accordance with the invention.

Denoted at “a” is an axial direction, at “r” a radial direction. For simplicity, FIG. 1 only represents a portion of the tyre, the remaining portion not shown being identical to, and disposed in symmetry with the radial direction “r”.

The tyre (100) comprises at least one carcass ply (101), the opposite lateral edges of which are associated with respective bead wires (102). The association between the carcass ply (101) and the bead wires (102) is achieved here by folding back the opposite lateral edges of the carcass ply (101) around the bead wires (102) so as to form the so-called carcass back-folds (110a) as shown in FIG. 1.

Alternatively, the conventional bead wires (102) can be replaced with a pair of circumferentially inextensible annular inserts formed from elongate components arranged in concentric coils (not represented in FIG. 1) (see, for example, European patent applications EP 928,680 and EP 928,702). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of elastomeric compound. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. Each bead wire (102) is enclosed in a bead (103), defined along an inner circumferential edge of the tyre (100), with which the tyre engages on a rim (not represented in FIG. 1) forming part of a vehicle wheel. The space defined by each carcass back-fold (101a) contains a bead filler (104) in which the bead wires (102) are embedded. An antiabrasive strip (105) is usually placed in an axially external position relative to the carcass back-fold (101a).

A belt structure (106) is applied along the circumference of the rubberized carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A side wall (108) is also applied externally onto the rubberized carcass ply (101), this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109), which can be produced according to the present invention, has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109). A underlayer which forms, with the tread band (109), a structure commonly known as a “cap and base” (not represented in FIG. 1) may optionally be placed between the belt structure (106) and the tread band (109).

A layer of elastomeric material (111) which serves as an “attachment sheet”, i.e. a sheet capable of providing the connection between the tread band (109) and the belt structure (106), may be placed between the tread band (109) and the belt structure (106).

In the case of tubeless tyres, a rubber layer (112) generally known as a “liner”, which provides the necessary impermeability to the inflation air of the tyre, may also be provided in a radially internal position relative to the rubberized carcass ply (101).

The process for producing the tyre according to the present invention can be carried out according to techniques and using apparatus that are known in the art, as described, for example, in patents EP 199 064, U.S. Pat. No. 4,872,822, U.S. Pat. No. 4,768,937, said process including at least one stage of manufacturing the green tyre and at least one stage of vulcanizing this tyre.

More particularly, the process for producing the tyre comprises the stages of preparing, beforehand and separately from each other, a series of semi-finished products corresponding to the various parts of the tyre (carcass plies, belt structure, bead wires, fillers, side walls and tread band) which are then combined together using a suitable manufacturing machine. Next, the subsequent vulcanization stage welds the abovementioned semi-finished products together to give a monolithic block, i.e. the finished tyre.

Naturally, the stage of preparing the above-mentioned semi-finished products will be preceded by a stage of preparing and moulding the various blends, of which said semi-finished products are made, according to conventional techniques.

The green tyre thus obtained is then passed to the subsequent stages of moulding and vulcanization. To this end, a vulcanization mould is used which is designed to receive the tyre being processed inside a moulding cavity having walls which are countermoulded to define the outer surface of the tyre when the vulcanization is complete.

Alternative processes for producing a tyre or parts of a tyre without using semi-finished products are disclosed, for example, in the abovementioned patent applications EP 928,680 and EP 928,702.

The green tyre can be moulded by introducing a pressurized fluid into the space defined by the inner surface of the tyre, so as to press the outer surface of the green tyre against the walls of the moulding cavity. In one of the moulding methods widely practised, a vulcanization chamber made of elastomeric material, filled with steam and/or another fluid under pressure, is inflated inside the tyre closed inside the moulding cavity. In this way, the green tyre is pushed against the inner walls of the moulding cavity, thus obtaining the desired moulding. Alternatively, the moulding can be carried out without an inflatable vulcanization chamber, by providing inside the tyre a toroidal metal support shaped according to the configuration of the inner surface of the tyre to be obtained as decribed, for example, in patent EP 242,840. The difference in coefficient of thermal expansion between the toroidal metal support and the crude elastomeric material is exploited to achieve an adequate moulding pressure.

At this point, the stage of vulcanizing the crude elastomeric material present in the tyre is carried out. To this end, the outer wall of the vulcanization mould is placed in contact with a heating fluid (generally steam) such that the outer wall reaches a maximum temperature generally of between 100° C. and 230° C. Simultaneously, the inner surface of the tyre is heated to the vulcanization temperature using the same pressurized fluid used to press the tyre against the walls of the moulding cavity, heated to a maximum temperature of between 100° C. and 250° C. The time required to obtain a satisfactory degree of vulcanization throughout the mass of the elastomeric material can vary in general between 3 min and 90 min and depends mainly on the dimensions of the tyre. When the vulcanization is complete, the tyre is removed from the vulcanization mould.

While the present invention has been specifically illustrated in connection with a tyre, other cross-linked elastomeric manufactured articles that can be produced according to the invention may be, for example, conveyor belts, driving belts or flexible tubes.

The present invention will be hereinafter further illustrated by some embodiments given by way of example only and thus not being restrictive of same.

### EXAMPLES 1-2

Preparation of the Elastomeric Compositions

The elastomeric compositions given in Table 1 (the amounts of the different components are expressed in phr) were prepared as follows.

All ingredients except zinc oxide, the antioxidant, sulphur and the accelerators, were mixed in an internal mixer (Pomini PL 1.6 model) for about 5 minutes. As soon as the temperature of 145±5° was reached, the elastomeric composition was discharged. Then zinc oxide and the antioxidant were added and mixing was carried out in an internal mixer (Pomini PL 1.6 model) for about 4 minutes. As soon as the temperature of 125±50 was reached, the elastomeric composition was discharged. Then sulphur and the accelerators were added and mixing was carried out in an open mill mixer equipped with cylinders.

TABLE 1

| Example | 1(*) | 2 |
|---|---|---|
| S-SBR | 90 | 90 |
| BR | 35 | 35 |
| Silica | 70 | 70 |
| Titanium dioxide | — | 1.12 |
| TESPT | 5.6 | 5.6 |
| Stearic acid | 2 | 2 |
| Aromatic oil | 8 | 8 |
| Microcrystalline wax | 1 | 1 |
| Zinc oxide | 2.5 | 2.5 |
| Antioxidant | 2 | 2 |
| CBS | 2 | 2 |
| DPG | 1.9 | 1.9 |
| Sulphur | 1.2 | 1.2 |

(*)comparative.
S-SBR: styrene/butadiene copolymer, obtained by solution polymerization, containing 25% by weight of styrene, mixed with 37.5 phr of oil (Buna ® 5025 - Bayer);
BR: cis-1,4-polybutadiene (Europrene ® BR 40 - EniChem Elastomeri);
Silica: precipitated silica (Zeosil ® 1165 MP - Rhône-Poulenc);
Titanium dioxide: purity: greater than 99%; surface area 8 m²/g; average diameter of particles: comprised between 20 nm and 200 nm; (Kronos ® 1002 - Kronos International);
TESPT: bis(3-triethoxysilylpropyl)tetrasulfide (X50S comprising 50% of carbon black and 50% of silane from Degussa - the reported amount relates to the silane amount);
Antioxidant: N-1,3-dimethylbutyl-N′-phenyl-p-phenylenediamine;
CBS (accelerator): N-cyclohexyl-2-benzotiazyl-sulfenamide (Vulkacit ® CZ - Bayer);
DPG (accelerator): N-N′-diphenylguanidine.

The Mooney viscosity ML(1+4) at 100° C. was measured, according to ISO standard 289/1, on the non-crosslinked compositions obtained as described above. The results obtained are given in Table 2.

Said elastomeric compositions were also submitted to a MDR rheometric analysis using a MDR rheometer from Monsanto, the tests being run at 151° C. for 60 minutes, with an oscillation frequency of 1.66 Hz (100 oscillations per minute) and an oscillation amplitude of +0.5°. The static mechanical properties according to ISO standard 37 as well as hardness in IRHD degrees at 23° C. according to ISO standard 48 were measured on samples of said elastomeric compositions cross-linked at 151° C. for 30 minutes. The results obtained are given in Table 2.

Also given in Table 2 are the dynamic mechanical properties measured using an Instron dynamic device in the traction-compression mode according to the following methods. A test piece of the crosslinked material having a cylindrical form (length=25 mm; diameter=14 mm) compression-preloaded up to 10% longitudinal deformation with respect to the initial length, and kept at the prefixed temperature (23° C. or 70° C.) for the whole duration of the test, was submitted to a dynamic sinusoidal strain with an amplitude ±3.33% with respect to the length under pre-load, with a frequency of 100 Hz. The dynamic mechanical properties are expressed in terms of dynamic elastic modulus (E′) and tandelta (loss factor) values. As is known, the tandelta value is calculated as a ratio between the viscous modulus (E″) and the elastic modulus (E′), both of them being determined with the above dynamic measurements.

Also measured were the DIN abrasion values according to ISO standard 4649, also given in Table 2, expressed as an index of a relative volumetric loss with respect to the reference composition of Example 1 (put to 100).

Finally, the amount of the reacted silane was measured. To this aim, a specimen in the form of a sheet with a thickness of 1 mm of said not cross-linked elastomeric compositions having a weight of about 1 g, was put into a Soxlet extractor with absolute ethanol for 24 hours so as to extract the unreacted silane therefrom. The extracted product was cooled, filtered and brought to volume with absolute ethanol. The amount of the extracted silane was determined by silica emission spectroscopy, using a plasma emission spectrometer SPECTRASPAN III model, by comparing the intensity of the obtained signal with a calibration curve obtained with solutions having a known concentration of silane in ethanol. The amount of the starting silane and the amount of the extracted silane being known, the amount of the reacted silane is given by the following formula:

$$\% reacted silane = 100 - [ \frac{A}{B \times M} ]$$

wherein:
A=silane concentration in ppm, determined in the specimen brought to volume in 100 ml of ethanol;
B=percent by weight of silane added to the elastomeric composition;
M=mass of the specimen in grams.

The obtained results are given in Table 2.

TABLE 2

| EXAMPLE | 1(*) | 2 |
|---|---|---|
| Mooney viscosity | 80 | 81 |
| ML (1 + 4) | | |

STATIC MECHANICAL PROPERTIES

| | | |
|---|---|---|
| 100% Modulus (MPa) | 2.09 | 2.06 |
| 300% Modulus (MPa) | 9.93 | 9.47 |
| Stress at break (MPa) | 14.40 | 14.35 |
| 300% Mod./100% Mod. | 4.27 | 4.59 |

DYNAMIC MECHANICAL PROPERTIES

| | | |
|---|---|---|
| E′ (23° C.) (MPa) | 8.12 | 8.36 |
| E′ (70° C.) (MPa) | 5.76 | 5.90 |
| Tandelta (23° C.) | 0.273 | 0.270 |
| Tandelta (70° C.) | 0.140 | 0.130 |

RHEOMETRIC PROPERTIES

| MH (dN m) | 21.1 | 20.9 |
|---|---|---|
| t30 (min) | 6.6 | 7.0 |
| t90 (min) | 8.0 | 8.1 |
| IRHD Hardness (23° C.) | 69 | 68 |
| IRHD Hardness (100° C.) | 65 | 64 |
| DIN abrasion (Index) | 100 | 88 |
| Reacted silane (%) | 87 | 92 |
| (*)comparative. | | |
| From the experimental results given in Table 2, it is possible to notice the following. Use of titanium dioxide in accordance with the present invention (Example 2) enables a stronger reinforcing effect to be obtained with respect to the comparative Example 1, | | |
| # as proved by the value of the 300% modulus/100% modulus ratio. In addition the cross-linked manufactured article has improved hysteresis properties, in particular lower tandelta values at 70° C. | | |
| # (i.e. less rolling resistance) and an improved abrasion resistance. Furthermore, the elastomeric composition in accordance with the present invention (Example 2) shows a higher reacted silane amount (%) as compared with the reference composition (Example 1). | | |
| # Said results show that titanium dioxide is able to promote the reaction between silica and coupling agent and, consequently, to promote the interaction between silica and elastomeric polymer. | | |

It should be also pointed out that the above effects were achieved without adversely affecting Mooney viscosity and vulcanisation kinetics.

1-25. (canceled)

26. A tyre for a vehicle wheel, comprising:
at least one element of cross-linked elastomeric material;
wherein the at least one element comprises an elastomeric composition, comprising:
at least one diene elastomeric polymer;
at least one reinforcing filler comprising silica;
at least one silica coupling agent comprising at least one hydrolyzable silane group; and
titanium dioxide;
wherein a weight ratio of the at least one silica coupling agent to the titanium dioxide is greater than or equal to 0.5:1.

27. The tyre of claim 26, comprising:
a carcass structure;
a belt structure applied to the carcass structure in a circumferentially external position relative to the carcass structure,
a tread band superimposed circumferentially on the belt structure;
a pair of sidewalls applied laterally on opposite sides relative to the carcass structure;
wherein the carcass structure comprises at least one carcass ply,
wherein the carcass structure comprises a substantially toroidal configuration,
wherein opposite lateral edges of the carcass structure are associated with respective bead wires,
wherein each bead wire is enclosed in a respective bead,
wherein the belt structure comprises at least one belt strip, and
wherein the at least one element comprising an elastomeric composition is the tread band.

28. The tyre of claim 26, wherein the weight ratio of the at least one silica coupling agent to the titanium dioxide is greater than or equal to 2:1 and less than or equal to 6:1.

29. The tyre of claim 26, wherein the at least one diene elastomeric polymer is selected from unsaturated-chain elastomeric polymers or copolymers having a glass transition temperature (T_{g}) lower than 20° C.

30. The tyre of claim 29, wherein the at least one diene elastomeric polymer is one or more of: cis-1,4-polyisoprene; 3,4-polyisoprene; polybutadiene; possibly halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

31. The tyre of claim 26, wherein the elastomeric composition further comprises at least one elastomeric polymer of at least one monoolefin with at least one olefinic comonomer or derivatives thereof.

32. The tyre of claim 26, wherein the elastomeric composition further comprises at least one thermoplastic polymer comprising a main hydrocarbon chain to which hydrophilic groups are bonded.

33. The tyre of claim 26, wherein the at least one reinforcing filler comprises silica having a BET surface area, measured according to ISO Standard 5794/1, greater than or equal to 50 m²/g and less than or equal to 500 m²/g.

34. The tyre of claim 26, wherein the elastomeric composition comprises the at least one reinforcing filler in an amount greater than or equal to 0.1 phr and less than or equal to 120 phr.

35. The tyre of claim 26, wherein the at least one silica coupling agent further comprises at least one sulphur atom.

36. The tyre of claim 26, wherein the at least one silica coupling agent is selected from compounds of formula:
Z-Alk-Sₙ-Alk-Z
wherein Z is selected from the following groups:
—Si(R₁)₂(R₂), —Si(R₁)(R₂)₂, and —Si(R₂)₃;
wherein R₁ is a C₁-C₄ alkyl group, a cyclohexyl, or a phenyl group,
wherein R₂ is a C₁-C₈ alkoxy group or a C₅-C₈ cycloalkoxy group,
wherein Alk is a divalent hydrocarbon group having from 1 to 18 carbon atoms, and
wherein n is a number greater than or equal to 2 and less than or equal to 8.

37. The tyre of claim 26, wherein the elastomeric composition comprises the at least one silica coupling agent in an amount greater than or equal to 1 phr and less than or equal to 15 phr.

38. The tyre of claim 26, wherein the titanium dioxide is selected from those having an NSA surface area, measured by surface absorption of nitrogen according to ISO Standard 5794/1, greater than or equal to 5 m²/g and less than or equal to 200 m²/g.

39. The tyre of claim 26, wherein the titanium dioxide is selected from those having an average particle diameter greater than or equal to 10 nm and less than or equal to 400 nm.

40. The tyre of claim 26, wherein the elastomeric composition comprises an amount of the titanium dioxide greater than or equal to 0.2 phr and less than or equal to 5 phr.

41. An elastomeric composition, comprising:
at least one diene elastomeric polymer;
at least one reinforcing filler comprising silica;
at least one silica coupling agent comprising at least one hydrolyzable silane group; and
titanium dioxide;
wherein a weight ratio of the at least one silica coupling agent to the titanium dioxide is greater than or equal to 0.5:1.

42. The composition of claim 41, wherein the weight ratio of the at least one silica coupling agent to the titanium dioxide is greater than or equal to 2:1 and less than or equal to 6:1.

43. The composition of claim 41, wherein the at least one diene elastomeric polymer is selected from unsaturated-chain elastomeric polymers or copolymers having a glass transition temperature (T_{g}) lower than 20° C.

44. The composition of claim 43, wherein the at least one diene elastomeric polymer is one or more of: cis-1,4-polyisoprene; 3,4-polyisoprene; polybutadiene; possibly halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

45. The composition of claim 41, further comprising at least one elastomeric polymer of at least one monoolefin with at least one olefinic comonomer or derivatives thereof.

46. The composition of claim 41, further comprising at least one thermoplastic polymer comprising a main hydrocarbon chain to which hydrophilic groups are bonded.

47. The composition of claim 41, wherein the at least one silica coupling agent comprises silica having a BET surface area, measured according to ISO Standard 5794/1, greater than or equal to 50 m²/g and less than or equal to 500 m²/g.

48. The composition of claim 41, wherein the elastomeric composition comprises the at least one reinforcing filler in an amount greater than or equal to 0.1 phr and less than or equal to 120 phr.

49. The composition of claim 41, wherein the at least one silica coupling agent further comprises at least one sulphur atom.

50. The composition of claim 41, wherein the at least one silica coupling agent is selected from compounds of formula:
Z-Alk-Sₙ-Alk-Z
wherein Z is selected from the following groups:
—Si(R₁)₂(R₂), —Si(R₁)(R₂)₂, and —Si(R₂)₃;
wherein R₁ is a C₁-C₄ alkyl group, a cyclohexyl, or a phenyl group,
wherein R₂ is a C₁-C₈ alkoxy group or a C₅-C₈ cycloalkoxy group,
wherein Alk is a divalent hydrocarbon group having from 1 to 18 carbon atoms, and
wherein n is a number greater than or equal to 2 and less than or equal to 8.

51. The composition of claim 41, wherein the titanium dioxide is selected from those having an NSA surface area, measured by surface absorption of nitrogen according to ISO Standard 5794/1, greater than or equal to 5 m²/g and less than or equal to 200 m²/g.

52. The composition of claim 41, wherein the titanium dioxide is selected from those having an average particle diameter greater than or equal to 10 nm and less than or equal to 400 nm.

53. The composition of claim 41, wherein the elastomeric composition comprises an amount of the titanium dioxide greater than or equal to 0.2 phr and less than or equal to 5 phr.

54. A tread band for a vehicle wheel tyre, comprising:
an elastomeric composition, comprising:
at least one diene elastomeric polymer;
at least one reinforcing filler comprising silica;
at least one silica coupling agent comprising at least one hydrolyzable silane group; and
titanium dioxide;
wherein a weight ratio of the at least one silica coupling agent to the titanium dioxide is greater than or equal to 0.5:1.

55. A cross-linked elastomeric manufactured article obtained by cross-linking an elastomeric composition, wherein the elastomeric composition comprises:
at least one diene elastomeric polymer;
at least one reinforcing filler comprising silica;
at least one silica coupling agent comprising at least one hydrolyzable silane group; and
titanium dioxide;
wherein a weight ratio of the at least one silica coupling agent to the titanium dioxide is greater than or equal to 0.5:1.
